(19) United States
(12) Patent Application Publication
(10) Pub. No.: US 2025/0184166 A1
(43) Pub. Date: Jun. 5, 2025

(54) INFORMATION PROCESSING APPARATUS, INFORMATION PROCESSING METHOD, AND NON-TRANSITORY RECORDING MEDIUM

(71) Applicant: PFU LIMITED, Ishikawa (JP)

(72) Inventors: Osamu MIYAKAWA, Ishikawa (JP); Ken FUNAKI, Ishikawa (JP)

(21) Appl. No.: 19/046,888

(22) Filed: Feb. 6, 2025

Related U.S. Application Data
(63) Continuation-in-part of application No. PCT/JP2022/031678, filed on Aug. 23, 2022.

(51) Int. Cl. H04L 12/10

(52) U.S. Cl. CPC H04L 12/10

(57) ABSTRACT

An information processing apparatus includes an information processor, a wireless communication processor to perform wireless communication based on control by the information processor, and a power supply device to supply power to the information processor and the wireless communication processor. The power supply device supplies electric power to the wireless communication processor to keep the wireless communication processor in a startup state before the information processor starts up.

### CROSS-REFERENCE TO RELATED APPLICATION

This patent application is a continuation application of International Application No. PCT/JP2022/031678, filed on Aug. 23, 2022, in the Japan Patent Office, the entire disclosure of which is hereby incorporated by reference herein.

### BACKGROUND

The present disclosure relates to an information processing apparatus, an information processing method, and a non-transitory recording medium.

An intelligent vehicle power management method applied to an intelligent vehicle power management apparatus and a mobile information terminal is known. The known intelligent vehicle power management apparatus includes a power supply module, a processing module electrically connected to the power supply module, and a wireless connection module electrically connected to the processing module. The power supply module includes a power switch and a battery electrically connected to the power switch. The intelligent vehicle power management method includes steps of the following (a) to (e):
(a) by the processing module, controlling the power supply module to temporarily be in a power supply state and supply the wireless connection module with required electric power, when the power switch is switched on to off;
(b) by the processing module, activating a timer to start timing;
(c) by the processing module, determining whether an elapsed time has reached a predetermined duration according to the timer;
(d) when it is determined that the elapsed time has reached the predetermined duration in step (c), stopping supplying electric power from the battery to the processing module and the wireless connection module, and suspending wireless connection between the wireless connection module and the mobile information terminal; and
(e) when it is determined that the elapsed time has not reached the predetermined duration in step (c), resetting the timer and controlling the timer to stop timing when the power switch is switched off to on.

Further, an information processing apparatus that processes a job received from an external device is known. The information processing apparatus includes communicating means for performing wireless communication in a sleep state or a soft-off state. The information processing apparatus includes storing means for storing device information indicating a device state of the information processing apparatus in a memory accessible when the communicating means performs the wireless communication. The information processing apparatus includes determining means for determining whether to execute a job based on the device information stored in the memory when the communicating means receives the job from the external device in the sleep state or the soft-off state. The information processing apparatus includes controlling means for controlling the information processing apparatus to return to a normal activation state and processing the job when the determining means determines that the job is to be executed, and for keeping the information processing apparatus in the sleep state or the soft-off state when the determining means determines that the job is not to be executed.

### SUMMARY

An information processing apparatus according to one aspect of the present disclosure includes an information processor, a wireless communication processor to perform wireless communication based on control by the information processor, and a power supply device to supply power to the information processor and the wireless communication processor. The power supply device supplies electric power to the wireless communication processor to keep the wireless communication processor in a startup state before the information processor starts up.

An information processing method according to another aspect of the present disclosure includes performing wireless communication by a wireless communication processor based on control by an information processor, and supplying electric power to the wireless communication processor to keep the wireless communication processor in an operating state before the information processor starts up.

A non-transitory recording medium according to still another aspect of the present disclosure stores a plurality of program codes which, when executed by a computer, causes the computer to perform a method. The method includes performing wireless communication by a wireless communication processor based on control by an information processor, and supplying electric power to the wireless communication processor to keep the wireless communication processor in an operating state before the information processor starts up.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a sequence diagram of startup of a known apparatus;

FIG. 1B is a sequence diagram of startup of a scanner apparatus according to an embodiment of the present invention;

FIG. 2 is a diagram illustrating an example of the overall configuration of an information processing system according to an embodiment of the present invention;

FIG. 3 is a diagram of an example of the hardware configuration and the software configuration of an information processing unit incorporated in the scanner apparatus according to an embodiment of the present invention;

FIG. 4 is a diagram of an example of the functional configuration of firmware of the scanner apparatus according to an embodiment of the present invention;

FIG. 5 is a flowchart of an operation of starting up the scanner apparatus when shipped from a factory and depicts a power supply status in each process according to an embodiment of the present invention; and

FIG. 6A and FIG. 6B (FIG. 6) are flowcharts of an operation of starting up the scanner apparatus at a customer's site and depicts a power supply status in each process according to an embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

The background of the present disclosure is described below.

Each time an apparatus starts up, startup processing including initialization of hardware incorporating operating system (OS) firmware has to be performed. Further, each time an apparatus starts up, a wireless local area network (LAN) driver (including wireless LAN-related software in apparatus firmware) and a wireless LAN chip have to be initialized. The initialization processing and processing for connecting to an access point are major factors that increase an apparatus startup duration.

By saving a snapshot with the wireless LAN connected and then performing only the hardware initialization at the next startup of the apparatus, the apparatus has to perform only the minimum initialization processing of the OS and firmware. This enables the apparatus to start up quickly. However, since a memory in a wireless LAN chip functions independently, information in the memory cannot be imported into the snapshot created by the main unit of the apparatus. In other words, although the memory in the wireless LAN chip is volatilized and information in the memory is lost when the device is turned on and off, restoration information of the wireless LAN chip cannot be included in the snapshot. Accordingly, each time the apparatus is turned on and off, the apparatus has to perform initialization processing of the wireless LAN driver and initialization processing of the wireless LAN chip included in the initialization processing of the wireless LAN driver. Each time the apparatus performs these initialization processing, the apparatus has to perform a wireless connection procedure.

In view of the above-described drawback, a scanner apparatus 2 according to the present disclosure can accelerate the startup by skipping processes from the initialization of the wireless LAN chip to the wireless connection sequence. The scanner apparatus 2 is an example of an information processing apparatus according to the present disclosure.

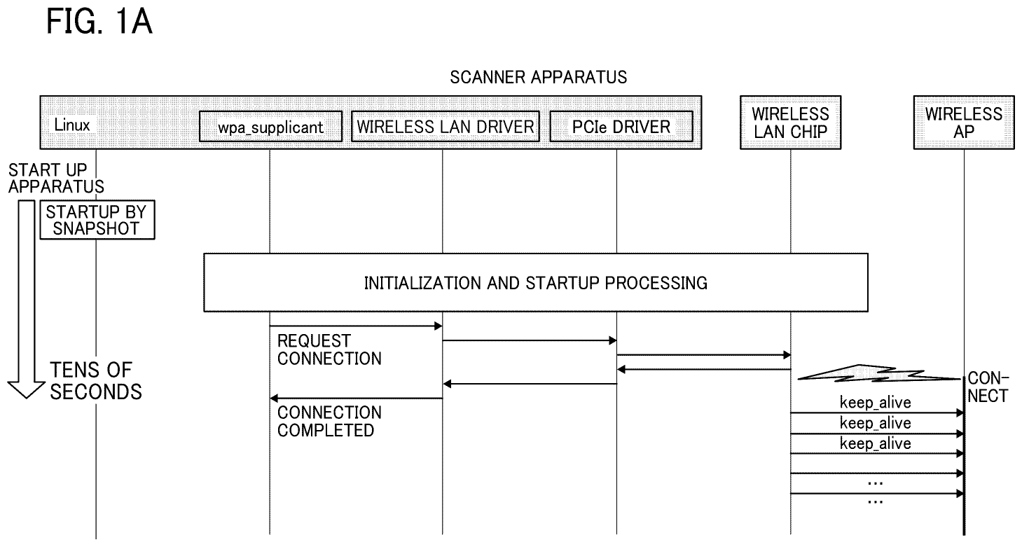

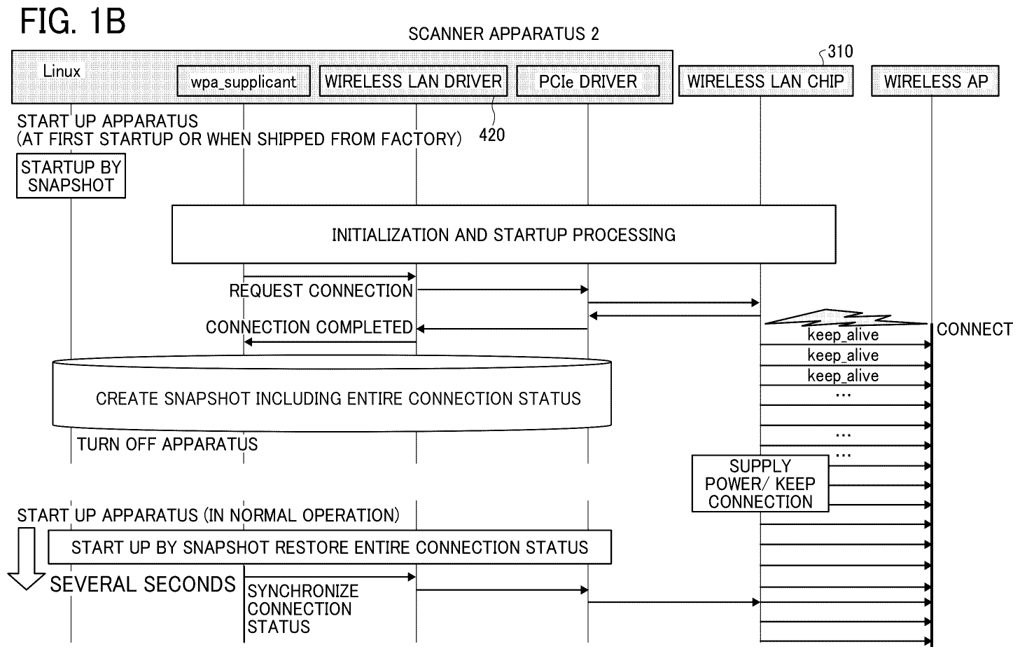

FIG. 1A is a sequence diagram of startup of a known apparatus. FIG. 1B is a sequence diagram of startup of the scanner apparatus 2.

As illustrated in FIG. 1A, a known apparatus can restore the entire startup state of Linux® or a device driver by snapshot startup. However, drivers and software relating to a wireless LAN cannot be included in the snapshot because a wireless LAN chip has to be initialized each time the apparatus is turned on and off. Accordingly, each time the apparatus starts up, the wireless LAN chip and the drivers and software relating to the wireless LAN chip have to be initialized after the snapshot startup, and then a wireless connection sequence has to be run. This greatly affects the apparatus startup duration.

On the other hand, as illustrated in FIG. 1B, the scanner apparatus 2 according to the present disclosure continues to supply electric power to a wireless LAN chip 310 described below even when the scanner apparatus 2 is off, thereby keeping the wireless LAN chip 310 wirelessly connected in terms of hardware. The scanner apparatus 2 includes the wireless connection states of a wireless LAN driver 420 described below and related software in a snapshot and restores the wireless connection states in their entirety. This enables the wireless LAN driver 420 and the related software to transition to the connection state by synchronizing with information in the wireless LAN chip 310 that is kept connected.

Thus, while it takes tens of seconds for a known apparatus to start up from a snapshot, the scanner apparatus 2 starts up in just a few seconds (less than 10 seconds).

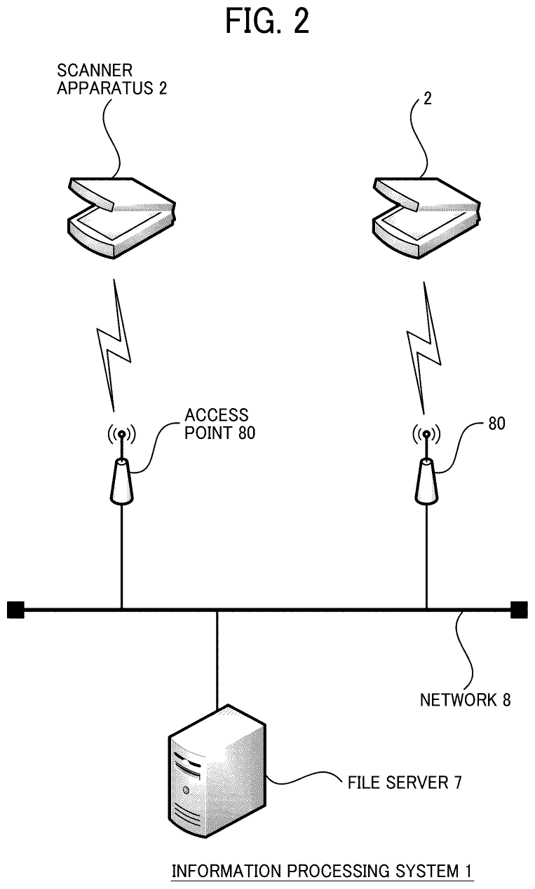

FIG. 2 is a diagram of an example of the overall configuration of an information processing system 1.

As illustrated in FIG. 2, the information processing system 1 includes the scanner apparatus 2 and a file server 7, which are connected to each other via an access point 80 and a network 8.

The scanner apparatus 2 is an image reading apparatus that generates image data by reading an image, and includes an information processing unit 20 that processes the image data. The scanner apparatus 2 of the present embodiment is connected to the network 8 via the access point 80 by wireless LAN and transmits the image data to the file server 7 via the network 8. The destination to which the image data is transmitted may be a cloud server, a personal computer, a smartphone, a tablet terminal, or the like, instead of the file server 7.

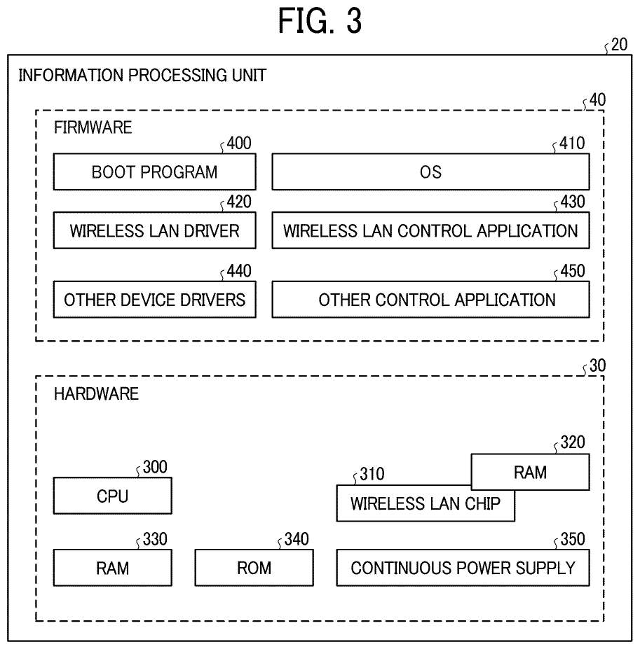

FIG. 3 is a diagram of an example of the hardware configuration and the software configuration of the information processing unit 20 incorporated in the scanner apparatus 2.

As illustrated in FIG. 3, the information processing unit 20 includes, as hardware 30, a central processing unit (CPU) 300, the wireless LAN chip 310, a random-access memory (RAM) 320, a RAM 330, a read-only memory (ROM) 340, and a continuous power supply 350. The CPU 300 is a central processing unit.

The wireless LAN chip 310 is a chip for performing wireless LAN communication under control by the information processing unit 20 and implement, for example, a Wi-Fi® connection. The wireless LAN chip 310 is an example of a wireless communication processor according to the present disclosure. The wireless LAN chip 310 remains connected to the access point 80 even while the information processing unit 20 is shut down. The RAM 320 is a volatile memory connected to the wireless LAN chip 310. The RAM 330 is a volatile memory and functions as a main memory (main storage device). The ROM 340 is a nonvolatile memory such as a flash ROM and stores, for example, a boot program including a snapshot. The information processing unit 20 is an example of an information processor according to the present disclosure.

The continuous power supply 350 supplies electric power to the wireless LAN chip 310 to keep the wireless LAN chip 310 in a startup state before the information processing unit 20 is started up. Specifically, before accelerated startup by a snapshot restoration unit 418 described below, the continuous power supply 350 stops supplying electric power to the information processing unit 20, continues supplying electric power only to the wireless LAN chip 310, and keeps the electric power within a preset value. The continuous power supply 350 is an example of a power supply device according to the present disclosure.

As illustrated in FIG. 3, the information processing unit 20 includes, as firmware 40, a boot program 400, an OS 410, a wireless LAN driver 420, a wireless LAN control application 430, other device drivers 440, and other control applications 450.

The boot program 400 is a boot program for starting up the scanner apparatus 2. The OS 410 is an example of an operating system (OS) and is a core part of Linux®).

The wireless LAN driver 420 is a driver for the wireless LAN chip 310.

The wireless LAN control application 430 controls the wireless LAN chip 310 via the wireless LAN driver 420 to implement wireless LAN communication with the access point 80.

The other device drivers 440 are drivers for a liquid crystal display, a touch panel, and the like.

The other control applications 450 are application programs that control a liquid crystal display or a touch panel to receive a user's input and display the result of the input.

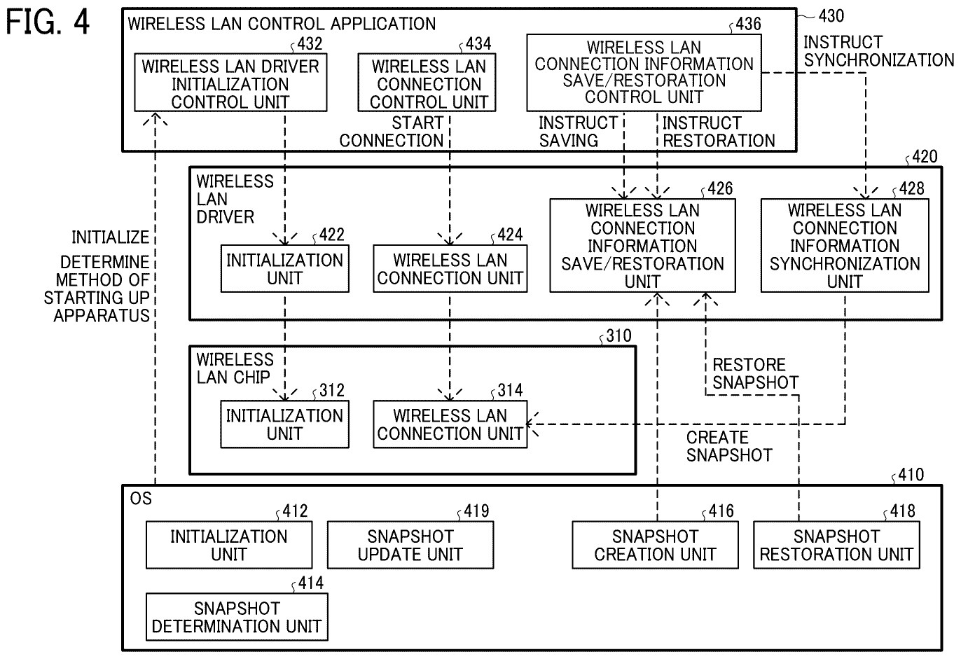

FIG. 4 is a diagram of an example of the functional configuration of the firmware 40 of the scanner apparatus 2.

As illustrated in FIG. 4, the OS 410 includes an initialization unit 412, a snapshot determination unit 414, a snapshot creation unit 416, a snapshot restoration unit 418, and a snapshot update unit 419. The initialization unit 412 initializes the OS 410. The snapshot determination unit 414 determines a method of starting up the scanner apparatus 2. The snapshot creation unit 416 creates a snapshot. The snapshot restoration unit 418 restores a snapshot. The snapshot update unit 419 includes wireless LAN connection information in a snapshot. The wireless LAN control application 430 includes a wireless LAN driver initialization control unit 432, a wireless LAN connection control unit 434, and a wireless LAN connection information save/restoration control unit 436. The wireless LAN driver initialization control unit 432 controls initialization of the wireless LAN driver 420 and determines the activation of the RAM 320 in wireless LAN chip 310. The wireless LAN connection control unit 434 controls wireless LAN connection. The wireless LAN connection information save/restoration control unit 436 controls the saving and restoration of wireless LAN connection information.

The wireless LAN driver 420 includes an initialization unit 422, a wireless LAN connection unit 424, a wireless LAN connection information save/restoration unit 426, and a wireless LAN connection information synchronization unit 428. The initialization unit 422 initializes the wireless LAN driver 420. The wireless LAN connection unit 424 performs wireless LAN connection processing. The wireless LAN connection information save/restoration unit 426 performs saving and restoring processing of wireless LAN connection information. The wireless LAN connection information synchronization unit 428 performs synchronization processing with the wireless LAN chip 310.

The wireless LAN chip 310 includes an initialization unit 312 that initializes the wireless LAN chip 310 and a wireless LAN connection unit 314 that performs wireless LAN connection.

The initialization unit 412 of the OS 410 initializes the OS 410 itself. The wireless LAN driver initialization control unit 432 of the wireless LAN control application 430 determines whether the RAM 320 in the wireless LAN chip 310 is activated via the initialization unit 422 of the wireless LAN driver 420. Further, the initialization unit 412 of the OS 410 notifies the wireless LAN control application 430 of the apparatus startup method based on whether a snapshot has been created by the snapshot determination unit 414. Specifically, after the startup using a snapshot, the snapshot determination unit 414 determines whether a snapshot has been created after shipment from a factory and notifies the wireless LAN driver initialization control unit 432 of the wireless LAN control application 430 of the startup method of the scanner apparatus 2 based on the determination result. When the snapshot determination unit 414 determines that a snapshot has not been created, the snapshot update unit 419 of the OS 410 restarts the wireless LAN driver 420, initializes the wireless LAN chip 310, and updates the wireless connection information in the snapshot.

The initialization unit 422 of the wireless LAN driver 420 performs initialization processing of the wireless LAN driver 420 and instructs initialization of the wireless LAN chip 310. The initialization unit 312 of the wireless LAN chip 310 initializes the wireless LAN chip 310.

The wireless LAN connection control unit 434 of the wireless LAN control application 430 instructs the wireless LAN connection unit 424 of the wireless LAN driver 420 to perform wireless LAN connection. The wireless LAN connection unit 314 of the wireless LAN chip 310 performs wireless LAN connection processing.

The snapshot creation unit 416 of the OS 410 creates a snapshot of the state in which the information processing unit 20 and the wireless LAN chip 310 are running. Specifically, the snapshot creation unit 416 creates the snapshot in a state in which the wireless LAN is connected. More specifically, the snapshot created by the snapshot creation unit 416 includes the wireless LAN driver 420 that controls the operation of the wireless LAN chip 310.

The snapshot restoration unit 418 starts up at least the wireless LAN chip 310 using the snapshot created by the snapshot creation unit 416. Specifically, the snapshot restoration unit 418 reads the snapshot stored in the ROM 340 and restores a memory state including information of the wireless LAN driver 420. The snapshot restoration unit 418 is an example of an accelerated startup unit according to the present disclosure.

The wireless LAN connection information save/restoration control unit 436 of the wireless LAN control application 430 instructs the wireless LAN driver 420 to save, restore, or synchronize the wireless LAN connection information. The wireless LAN connection information save/restoration unit 426 performs saving or restoring processing of the wireless LAN connection information based on the saving or restoring instruction.

The wireless LAN connection information synchronization unit 428 of the wireless LAN driver 420 synchronizes the wireless connection state between the information processing unit 20 and the wireless LAN chip 310 after the accelerated startup by the snapshot restoration unit 418. Specifically, the wireless LAN connection information synchronization unit 428 of the wireless LAN driver 420 performs synchronization processing with the wireless LAN connection unit 314 of the wireless LAN chip 310 based on the synchronization instruction from the wireless LAN connection information save/restoration control unit 436 of the wireless LAN control application 430. The wireless LAN connection information synchronization unit 428 is an example of a wireless connection synchronization unit according to the present disclosure.

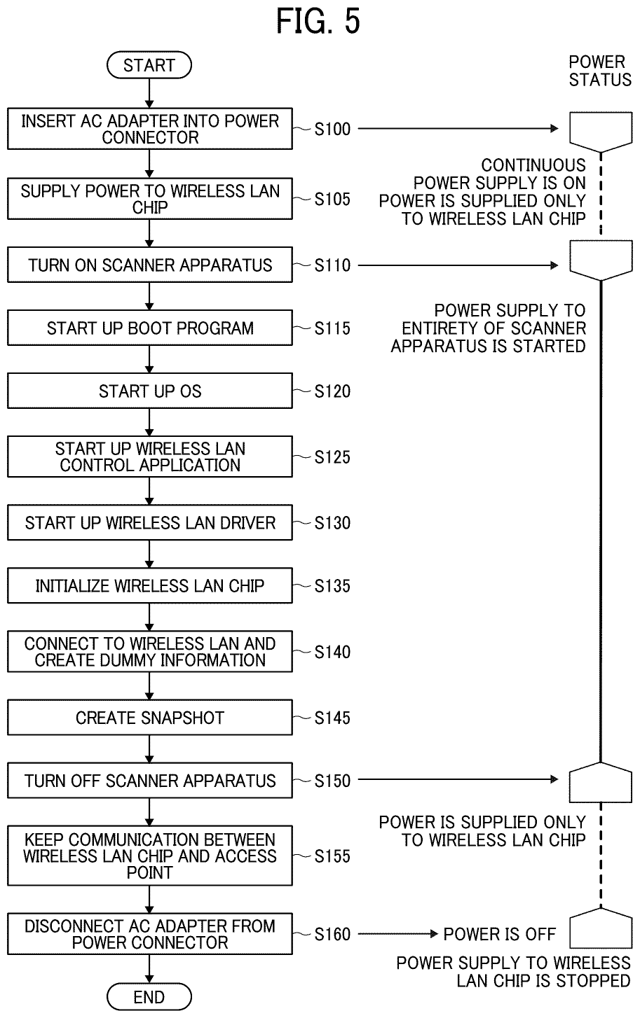

FIG. 5 is a flowchart of an operation of starting up the scanner apparatus 2 when shipped from a factory. FIG. 5 further depicts a power supply status in each process.

As illustrated in FIG. 5, in step 100 (S100), an alternating current (AC) adapter is inserted into the power connector of the scanner apparatus 2.

In step 105 (S105), the continuous power supply 350 supplies electric power to the wireless LAN chip 310. The power supply status is a state in which electric power is supplied only to the wireless LAN chip 310.

In step 110 (S110), the scanner apparatus 2 is turned on in response to a user operation. The power supply status is a state in which electric power is supplied to the entirety of the scanner apparatus 2.

In step 115 (S115), the boot program 400 of the firmware 40 starts up.

In step 120 (S120), the boot program 400 loads the kernel and starts the OS 410.

In step 125 (S125), the wireless LAN control application 430 starts up.

In step 130 (S130), the wireless LAN control application 430 starts up the wireless LAN driver 420.

In step 135 (S135), the initialization unit 312 of the wireless LAN chip 310 initializes the wireless LAN chip 310.

In step 140 (S140), the wireless LAN connection control unit 434 of the wireless LAN control application 430 instructs the wireless LAN connection unit 424 of the wireless LAN driver 420 to connect to the wireless LAN, and the wireless LAN connection unit 314 of the wireless LAN chip 310 performs wireless connection in the factory and creates dummy wireless connection information.

In step 145 (S145), the snapshot creation unit 416 creates a snapshot on the RAM 330. The snapshot creation unit 416 also includes in the snapshot a state in which the wireless LAN driver 420 is operating. The scanner apparatus 2 writes and stores the snapshot created on the RAM 330 in the ROM 340.

In step 150 (S150), the scanner apparatus 2 turns off in response to a user operation.

The power supply status is a state in which electric power supply to the scanner apparatus 2 is stopped except for the wireless LAN chip 310.

In step 155 (S155), the wireless LAN connection unit 314 of the wireless LAN chip 310 keeps communication between the wireless LAN chip 310 and the access point 80. In other words, the power supply status is a state in which electric power supply to the wireless LAN chip 310 only continues.

In step 160 (S160), the AC adapter is disconnected from the power connector of the scanner apparatus 2. The power supply status is a state in which electric power supply to the wireless LAN chip 310 is also stopped.

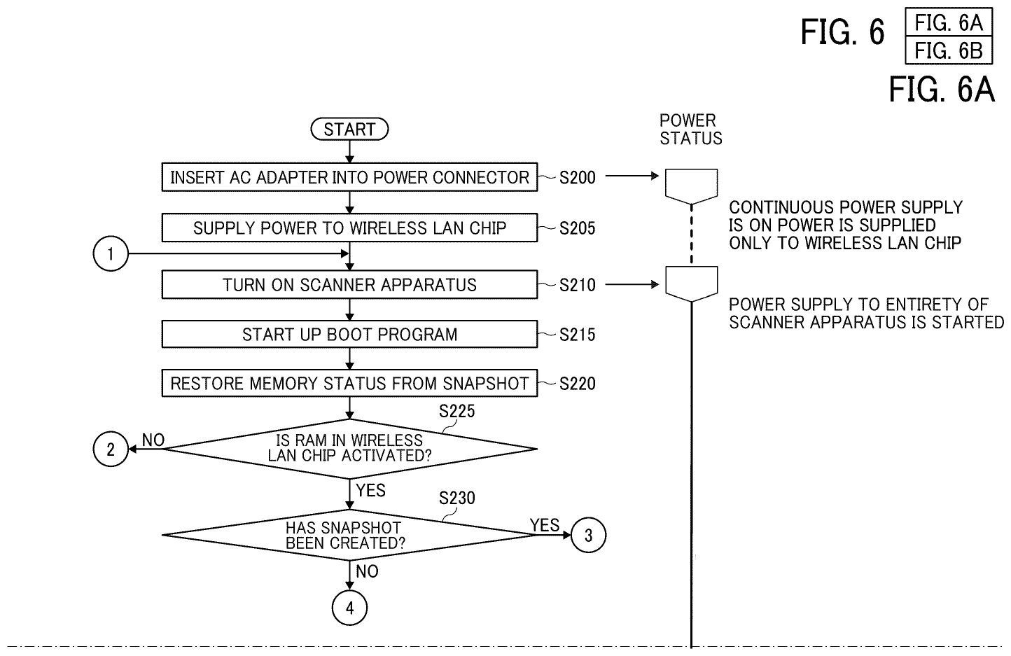

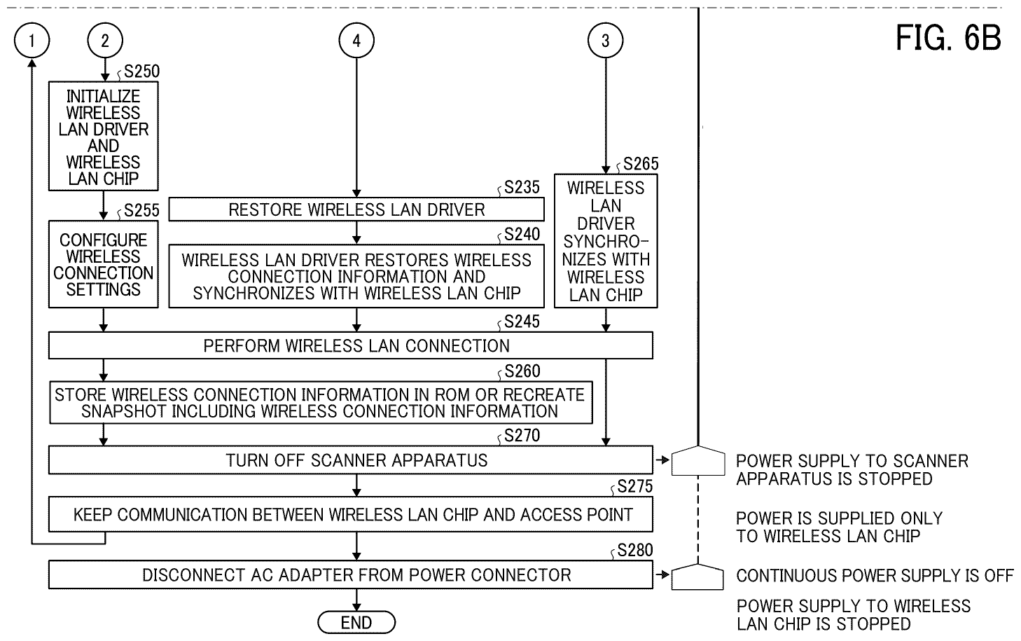

FIG. 6A and FIG. 6B (FIG. 6) are flowcharts of an operation of starting up the scanner apparatus 2 at a customer's site. FIG. 6A and FIG. 6B (FIG. 6) further depict a power supply status in each process.

As illustrated in FIG. 6A and FIG. 6B (FIG. 6), in step 200 (S200), the AC adapter is inserted into the power connector of the scanner apparatus 2.

In step 205 (S205), the continuous power supply 350 supplies electric power to the wireless LAN chip 310. The power supply status is a state in which electric power is supplied only to the wireless LAN chip 310.

In step 210 (S210), the scanner apparatus 2 is turned on in response to a user operation. The power supply status is a state in which electric power is supplied to the entirety of the scanner apparatus 2.

In step 215 (S215), the boot program 400 of the firmware 40 starts up.

In step 220 (S220), the snapshot restoration unit 418 reads the snapshot from the ROM 340, expands the snapshot in the RAM 330, and restores the memory state.

In step 225 (S225), the wireless LAN driver initialization control unit 432 of the wireless LAN control application 430 determines whether the RAM 320 of the wireless LAN chip 310 is activated via the initialization unit 422 of the wireless LAN driver 420. When the wireless LAN driver initialization control unit 432 determines that the RAM 320 of the wireless LAN chip 310 is activated (S225: Yes), i.e., when the AC power is not disconnected from the scanner apparatus 2, the operation proceeds to S230. When the wireless LAN driver initialization control unit 432 determines that the RAM 320 of the wireless LAN chip 310 is not activated (S225: No), i.e., when the AC power is disconnected from the scanner apparatus 2, the operation proceeds to S250.

In step 230 (S230), the snapshot determination unit 414 determines whether a snapshot has been recreated. When the snapshot determination unit 414 determines that the snapshot has not been recreated (S230: No), the operation proceeds to S235. When the snapshot determination unit 414 determines that the snapshot has been recreated (S230: Yes), the operation proceeds to S265.

In step 235 (S235), the snapshot restoration unit 418 restores the wireless LAN driver 420 using the snapshot.

In step 240 (S240), the wireless LAN connection information save/restoration unit 426 of the wireless LAN driver 420 restores the wireless connection information from the ROM 340, and the wireless LAN connection information synchronization unit 428 performs synchronization processing with the wireless LAN chip 310.

In step 245 (S245), the wireless LAN connection unit 314 of the wireless LAN chip 310 performs wireless LAN connection based on a wireless connection setting. In step 250 (S250), the initialization unit 422 of the wireless LAN driver 420 initializes the wireless LAN driver 420, and the initialization unit 312 of the wireless LAN chip 310 initializes the wireless LAN chip 310. By the initialization, the RAM 320 in the wireless LAN chip 310 is activated.

In step 255 (S255), the wireless LAN connection unit 424 reads the wireless connection information from the ROM 340 and performs wireless connection. When the connection is not established, the user configures a wireless connection setting. Then, in S245, the wireless LAN connection unit 424 performs wireless LAN connection.

In step 260 (S260), the wireless LAN connection information save/restoration control unit 436 of the wireless LAN control application 430 instructs the wireless LAN driver 420 to save the wireless LAN connection information. The wireless LAN connection information save/restoration unit 426 of the wireless LAN driver 420 stores the wireless connection information of the wireless LAN driver 420 in the ROM 340.

Alternatively, the snapshot update unit 419 of the OS 410 recreates a snapshot including the wireless connection information.

In step 265 (S265), the wireless LAN connection information synchronization unit 428 performs synchronization processing with the wireless LAN chip 310. Then, in S245, the wireless LAN connection information synchronization unit 428 performs wireless LAN connection.

In step 270 (S270), the scanner apparatus 2 turns off in response to a user operation. The power supply status is a state in which electric power supply to the scanner apparatus 2 is stopped except for the wireless LAN chip 310.

In step 275 (S275), the wireless LAN connection unit 314 of the wireless LAN chip 310 keeps communication between the wireless LAN chip 310 and the access point 80. In other words, the power supply status is a state in which electric power supply to the wireless LAN chip 310 only continues. When the scanner apparatus 2 is next started up from the state of S275, the startup operation is performed from S210.

In step 280 (S280), the AC adapter is disconnected from the power connector of the scanner apparatus 2. The power supply status is a state in which electric power supply to the wireless LAN chip 310 is also stopped. Since the electronic power supply is stopped, the RAM 320 in the wireless LAN chip 310 is in the inactive state.

As described above, the scanner apparatus 2 according to the present disclosure continues to supply electric power to the wireless LAN chip 310 even when the scanner apparatus 2 is turned off, thereby keeping only the wireless LAN chip 310 wirelessly connected. This enables the scanner apparatus 2 to skip the process of initializing the wireless LAN chip 310 when the scanner apparatus 2 is turned on. Further, the scanner apparatus 2 includes a wireless LAN connection state in a snapshot or stores wireless LAN connection information in a nonvolatile memory. The next time the scanner apparatus 2 starts up, the scanner apparatus 2 performs synchronization processing with the wireless LAN chip 310 based on the snapshot or the wireless connection information stored in the nonvolatile memory, thereby skipping the wireless sequence. This accelerates the startup of the scanner apparatus 2.

According to an embodiment of the present disclosure, the startup of an information processing apparatus is accelerated.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality. There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information processing apparatus, comprising:
an information processor;
a wireless communication processor to perform wireless communication based on control by the information processor; and
a power supply device to supply power to the information processor and the wireless communication processor,
wherein the power supply device supplies electric power to the wireless communication processor to keep the wireless communication processor in a startup state before the information processor starts up.

2. The information processing apparatus according to claim 1, wherein the information processor includes circuitry configured to:
create a snapshot of a state in which the information processor and the wireless communication processor are running; and
perform startup of at least the information processor by using the snapshot.

3. The information processing apparatus according to claim 2, wherein
the wireless communication processor is a wireless local area network (LAN) chip, and
the power supply device stops supplying electric power to the information processor and continues to supply electric power only to the wireless LAN chip before the startup.

4. The information processing apparatus according to claim 3, wherein
the wireless LAN chip is connected to an access point even while the information processor is shut down, and
the circuitry synchronizes a wireless connection state between the information processor and the wireless LAN chip after the startup.

5. The information processing apparatus according to claim 2, wherein
the wireless communication processor is a wireless LAN chip, and
the snapshot includes a snapshot of a wireless LAN driver that controls an operation of the wireless LAN chip.

6. The information processing apparatus according to claim 2, wherein
the wireless communication processor includes a wireless LAN chip, and
the circuitry:
determines whether another snapshot has been created after shipment from a factory after the startup using the snapshot; and
initializes the wireless LAN chip and updates wireless connection information in the snapshot when it is determined that the another snapshot has not been created.

7. An information processing method, comprising:
performing wireless communication by a wireless communication processor based on control by an information processor; and
supplying electric power to the wireless communication processor to keep the wireless communication processor in an operating state before the information processor starts up.

8. The information processing method according to claim 7, further comprising:
performing wireless connection by the wireless communication processor before shipment from a factory; and
creating a snapshot of a state in which the information processor and the wireless communication processor are running and a state in which the wireless connection has been performed.

9. A non-transitory recording medium storing a plurality of program codes which, when executed by a computer, causes the computer to perform a method, the method comprising:
performing wireless communication by a wireless communication processor based on control by an information processor; and
supplying electric power to the wireless communication processor to keep the wireless communication processor in an operating state before the information processor starts up.
